(19) United States
(12) Patent Application Publication
(10) Pub. No.: US 2008/0224619 A1
(43) Pub. Date: Sep. 18, 2008

(54) AUXILIARY POWER SUPPLY FOR LIGHTING BALLASTS

(76) Inventors: Simon Richard Greenwood, Altrincham (GB); Stephen Soar, Garstang (GB)

Correspondence Address: BRINKS HOFER GILSON & LIONE, P.O. BOX 10395, CHICAGO, IL, 60610, US

(21) Appl. No.: 11/687,446

(22) Filed: Mar. 16, 2007

(51) Int. Cl. H05B 41/14

(52) U.S. Cl. 315/160

(57) ABSTRACT

Auxiliary power is provided on a lighting ballast by a charge pump circuit. A direct current power supply circuit in the ballast outputs auxiliary power for operation of loads other than the lighting load of the ballast.

### BACKGROUND

This invention relates to a power supply associated with lighting. High intensity discharge (HID) lamps, incandescent lamps, fluorescent and other light sources operate with ballasts. The ballasts include electronics for operating these lighting loads. The electronics are typically powered from the mains power.

U.S. Published application No. Ser. ______ (Ser. No. 11/442,627, filed May 26, 2006) shows an example of a ballast with power for the electronics supplied internally. FIG. 1 shows an example HID lamp ballast similar to FIGS. 1 and 2 of the application referenced above. The power supply for the on-board electronics is derived from a secondary winding on the inductor L5 of the power factor controller (see 106 of FIG. 1 of the '627 application). The power supply includes the secondary winding of the inductor L5, resistor R28, capacitor C22, zener diode ZD4, diode D15, and capacitor C30. This power supply is a charge pump circuit. The charge pump circuit generates a direct current voltage for operation of electronics.

The power factor controller switches the incoming mains voltage alternately between being applied directly across the primary winding of the inductor L5 and being allowed to fly back into the storage capacitors via the freewheel diode. The peak-to-peak voltage across the primary winding of inductor L5 is substantially constant due to the voltage regulation function of the power factor control. The voltage occurring at the secondary winding of the inductor L5 is similarly a regulated peak-to-peak voltage and in proportion to the primary voltage by the ratio of the winding turns of the primary winding to the secondary winding. There is an offset in the distribution of the volt time integral positive and negative in sympathy with the instantaneous voltage of the incoming mains supply. This offset voltage is removed by the capacitor C22, which acts to pass the high frequency square wave element caused by the switching of the power factor controller while presenting a high impedance to the low frequency AC component due to the voltage over time change of the mains supply. A zener diode ZD4 further regulates the voltage and limits any transients during start up or load change conditions where the voltage regulation of the power factor controller is able to overshoot momentarily. The negative voltage excursions are clamped by the reverse diode characteristics of the zener diode ZD4, and the positive excursions are clamped by the zener voltage of the zener diode ZD4. These positive excursions cause the forward biasing of the diode D15, which rectifies the peak voltage onto the capacitor C30. A DC supply voltage is provided at the capacitor C30 and diode D15 node.

Other circuits or devices outside the ballast have separate power supplies. For example, a separate power supply is used for a cooling fan load or control panel indicator lamp.

### BRIEF SUMMARY

The present invention is defined by the following claims and nothing in this section should be taken as a limitation on those claims. By way of introduction, the preferred embodiments described below include systems, methods, and ballasts for auxiliary power. A power supply circuit in the ballast outputs auxiliary power for operation of loads other than the lighting load of the ballast, such as cooling fan load or control panel indicator lamp.

In a first aspect, a lighting ballast is provided. Electronics are operable to ballast a lighting load from power at a mains input. A first power supply circuit for the electronics is powerable by the power at the mains input. A second power supply circuit separate from the first power supply circuit is provided. An auxiliary power output of the ballast connects with the second power supply circuit.

In a second aspect, a method is provided for powering devices adjacent a lighting ballast. A ballast ballasts a lighting load from a mains power. Operation of the ballast is powered from the mains power. An auxiliary direct current output is supplied from the ballast. The auxiliary direct current output is powered from the mains power.

In a third aspect, a system is provided for auxiliary power supply associated with lighting. A high intensity discharge lighting ballast is provided. An auxiliary direct current output is on the lighting ballast.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a circuit diagram of an electronic high intensity discharge lamp ballast in one embodiment;

FIG. 2 is a circuit diagram of a high intensity discharge ballast with an additional auxiliary power supply circuit according to one embodiment;

FIG. 3 is a detailed circuit diagram of the ballast of FIG. 2; and

FIG. 4 is a flow chart diagram of one embodiment of a method for powering devices adjacent a lighting ballast.

### DETAILED DESCRIPTION OF THE DRAWINGS AND PRESENTLY PREFERRED EMBODIMENTS

An extra power supply circuit in a ballast may power auxiliary equipment. The auxiliary power supply is a substantially fixed voltage supply derived from an electronic ballast operable from variable or universal mains voltages in one embodiment.

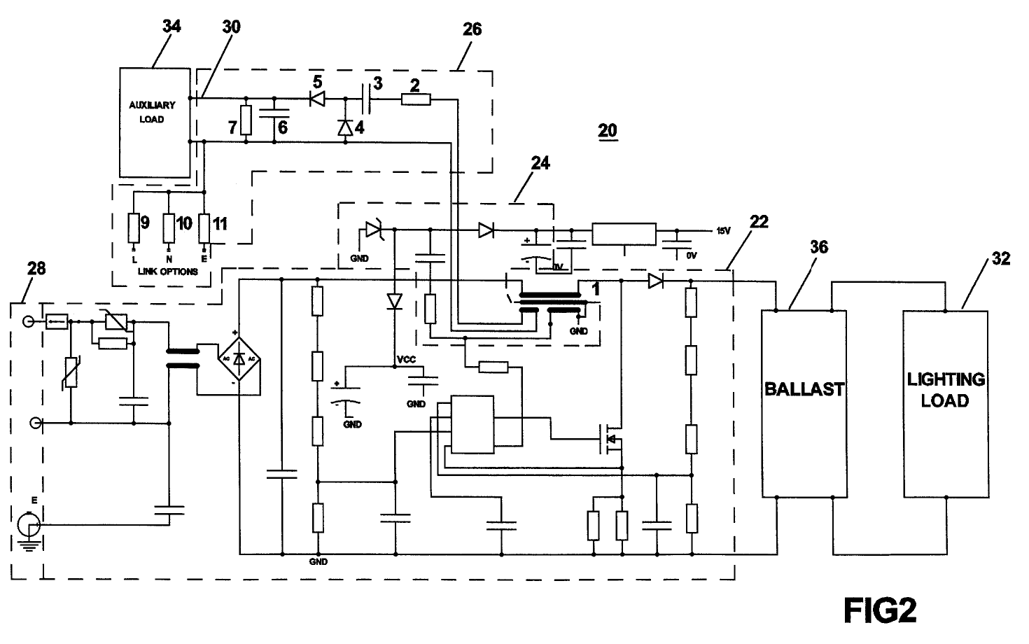

FIG. 2 shows a system 20 for auxiliary power supply associated with lighting. The system 20 includes a power factor controller 22 with an internal power supply circuit 24, a mains input 28, an auxiliary power supply circuit 26, and an auxiliary power output 30. Additional, different, or fewer components may be provided. For example, a lighting load 32 and an auxiliary load 34 connect with the power factor controller 22 and ballast 36 and auxiliary power output 30, respectively.

The ballast 36 is a lighting ballast, such as a high intensity discharge, fluorescent, or other now known or later developed lighting ballast. For example, the ballast 36 is one of the ballasts shown in U.S. Pat. Nos. 6,188,183, 6,495,971, or 6,384,544, or U.S. Published patent application Ser. No. ______ (Ser. No. 11/442,627, filed May 26, 2006), the disclosures of which are incorporated by reference herein. The ballast may be a different type of ballast, such as ballasts described in the background sections of the above referenced disclosures or other ballasts.

The power factor controller 22 and the ballast 36 includes electronics operable to ballast the lighting load 32 from power at the mains input 28. The electronics include switches (e.g., MOSFETs), a controller (e.g., power factor and/or switch control), a processor, an integrated circuit, combinations thereof, or other now known or later developed devices for electronically controlling operation of the power factor controller 22 and the ballast 36. The electronics are powered with direct current for operation. The direct current power is provided by the internal power supply circuit 24.

The power factor controller 22 is operable with a variable or universal mains input, such as allowing 277 Volt, to 120 Volt or other mains voltage connections. In other embodiments, the mains input 28 and ballast 36 are for a specific mains input, such 277 or 120 Volt main input. Power supplied at the mains input 28 is used to power the lighting load 32, the electronics of the power factor controller 22 and the ballast 36, and the auxiliary load 34 at the output 30.

The internal power supply circuit 24 provides direct current power to the electronics of the power factor controller 22 and the ballast 36. The power at the mains input 28 powers the internal power supply circuit 24. Either a direct or an indirect connection with the mains input 28 provides power. Connection at other locations within the ballast may be used to power the internal power supply circuit 24.

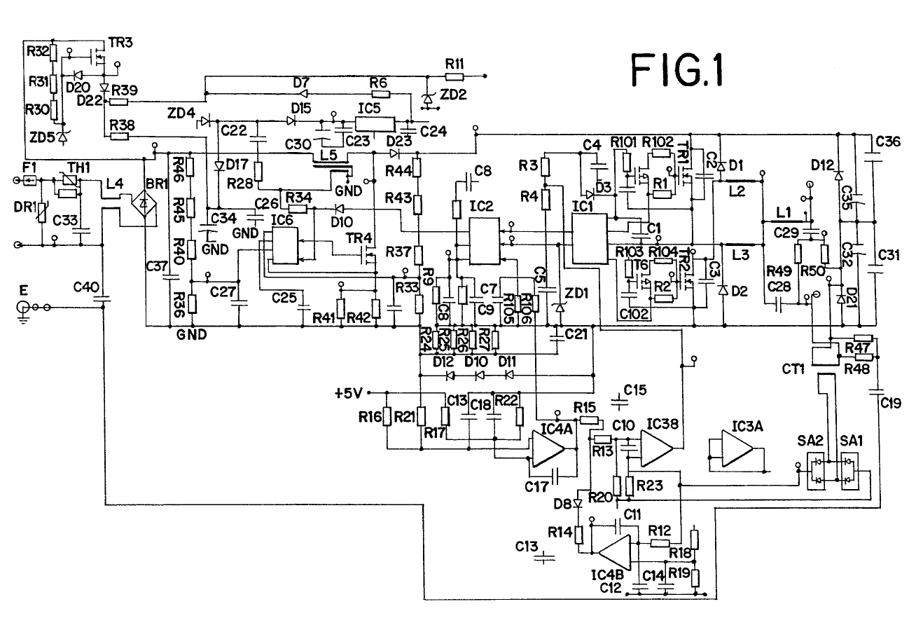

The internal power supply circuit 24 is any now known or later developed circuit for generating a direct current from the mains or from signals generated from the mains. For example, the internal power supply circuit 24 is a pump charge circuit. In one embodiment, the pump charge circuit includes the secondary winding of a power factor controller inductor, a resistor and capacitor in series with the secondary winding, a zener diode connected between the capacitor and a reference potential, and a diode connected between the capacitor and another capacitor. The pump charge circuit of this embodiment is shown in FIG. 1 and described above. Other pump charge circuits may be used with fewer, more, or different components. Other power supply circuits may be used.

The auxiliary power supply circuit 26 is separate from the internal power supply circuit 24. In one embodiment, the power supply circuits 24, 26 connect with a same source, but have separate components. One or more components may be shared, but some components are only part of one or each of the power supply circuits 24, 26. Alternatively or additionally, a separate output and/or input separate the power supply circuits 24, 26. Other separations may be provided. In other embodiments, a single power supply circuit 24, 26 is used for both auxiliary and internal direct current power supply.

The auxiliary power supply circuit 26 is operable to output a direct current to the auxiliary power output 30. Any level of output may be used, such as 45 volts. In alternative embodiments, the auxiliary power supply circuit 26 outputs alternating current or an adjustable direct current power. One auxiliary power supply circuit 26 is shown, but additional of the same or different type of auxiliary power supply circuits may be provided.

The auxiliary power supply circuit 26 is any now known or later developed circuit for generating power from the mains or signals generated from the mains. The auxiliary power supply circuit 26 is a same or different type of power supply circuit as the internal power supply circuit 24.

In one example, the auxiliary power supply circuit 26 is a charge pump circuit. Other pump charge circuits may be used with fewer, more, or different components.

In one embodiment, the charge pump circuit includes another secondary winding of the power factor controller inductor 1. This further secondary winding has any desired turns ratio, such as 10:1. For example, the bus voltage of the power factor controller is about 450 volts. A turns ratio of 10:1 provides for a 45 volt signal. The peak-to-peak voltage appearing across the primary of the power factor controller inductor 1 is substantially constant due to the voltage regulation function of such power factor control circuits. The voltage occurring at the secondary winding of the power factor controller inductor 1 is a similarly regulated peak-to-peak voltage. Other transformers or inductors may be used. The same secondary winding may be used for both power supply circuits 24, 26.

A resistor 2 and a capacitor 3 are connected in series with the secondary winding of the inductor 1. The resistor 2 and capacitor 3 limit the instantaneous surge current that may be caused by transient noise on the circuit and limit conducted disturbance from the mains voltage supply. A high pass filtering operation is provided. The high frequency square wave element caused by the switching of the power factor controller is passed while presenting a high impedance to the low frequency element. The fundament frequency (e.g., 60 Hz) and/or the second harmonic of the main supply are reduced or removed. The low frequency element due to the voltage over time change of the mains supply is limited. Other filters and/or components may be used.

A zener diode 4 connects between the capacitor 3 and a reference potential, such as a local ground. The diode 4 limits the negative excursions of the voltage at the capacitor 3-diode 4 node. The negative voltage is limited to the forward bias drop, such as 0.7 volts, of the diode 4. Other diodes, transistors, components, or networks may be used to limit the negative voltage.

A diode 5 connects between the capacitor 3-diode 4 node and another capacitor 6. The diode 5 passes the positive excursions of voltage forward to charge the capacitor 6. The capacitor 6 causes a direct current signal at the auxiliary output 30 based on the charging. Other diodes and/or capacitor arrangements may be used.

A resistor 7 connects in parallel with the capacitor 6. The resistor 7 provides a discharge path for operation without the auxiliary load 34. The resistor 7 may prevent shock hazard and control the open circuit output voltage of the circuit 26.

The auxiliary power supply circuit 26 is connected to a local reference potential. In one embodiment, reference potential connectors or links are provided to allow connection with different reference potentials. Switches, transistors, relays, or other devices connectors allowing for internal selection between different reference potentials. In other embodiments, the reference potential connectors are ports or external connectors. The desired reference potential is manually connected with the connectors. Different connectors are provided for the different possible reference potentials, such as separate connectors for line, neutral, and earth potentials. Only one connector may be provided for connection to the desired reference. The connectors may be left floating.

The auxiliary output 30 is a port, plug, prong, pad, connector, conductor, or other device for electrical connection of an external component to the ballast 22. The auxiliary output 30 is on or in a housing of the lighting ballast 22 and connects with the auxiliary power supply 24. The auxiliary output 30 provides direct current power, such as a constant voltage.

The auxiliary load 34 is any device with an input for power. For example, the auxiliary load 34 is a fan, indicator light, heater element, circuit, combinations thereof, or other now known or later developed load to connect with the auxiliary output 30 for power.

The connection between the auxiliary load 34 and the auxiliary power output 30 is a plug and socket, pressure (e.g., bolt and conductive pad), wire insertion, or other now know or later developed connector.

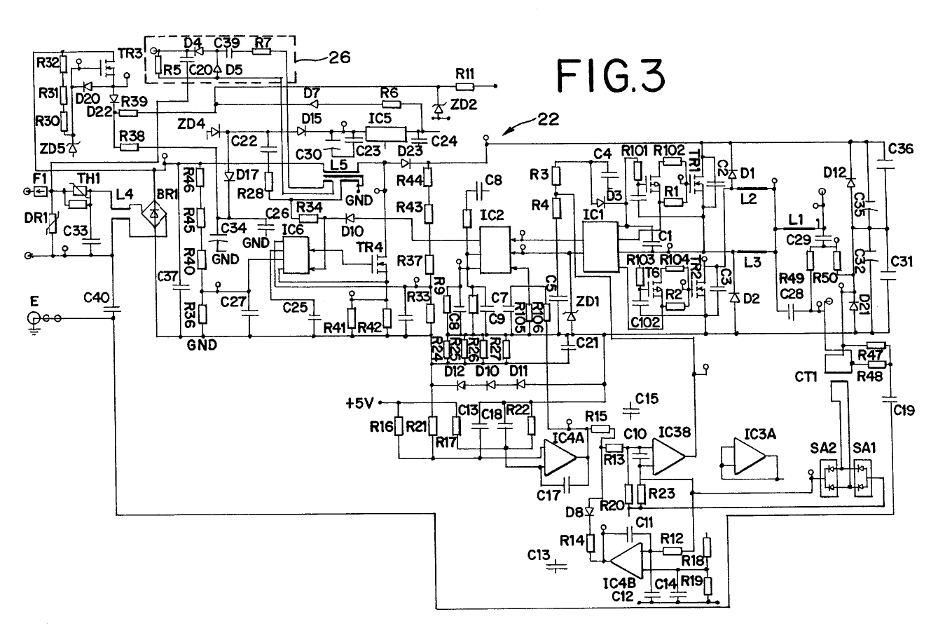

FIG. 3 shows one specific embodiment of the ballast 22 with the auxiliary power supply circuit 26 of FIG. 2. Example component values are provided. The reference potential of the auxiliary power supply circuit 26 is connected internally to the line potential. Other ballasts 22 may be used.

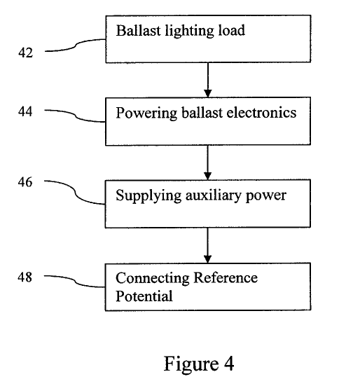

FIG. 4 shows a method for powering devices adjacent a lighting ballast. Fans, indicator lights, heater elements, circuits, combinations thereof, or other now known or later developed loads are powered from a lighting ballast. Additional, different, or fewer acts may be provided. The acts are performed in the order shown or a different order.

A ballast is installed with or adjacent to a lighting load. The ballast is connected to wires providing mains power. Other connections may be provided, such as connecting wires from an auxiliary load to the ballast.

In act 42, a lighting load is ballasted from mains power. For example, the mains power is converted into a signal for operating a high intensity discharge lamp. Electronics operate switches or other devices to convert the signal into a form appropriate for operating the lighting load. The ballasting may include striking or starting operation. Any now know or later developed ballasting may be used.

In act 44, operation of the ballast is powered from the mains power. For example, a direct current is generated from a power factor inductor. High frequency or other components are transformed to a desired voltage level. The transformed signal is rectified and charges a capacitor. The capacitor is sized to provide a substantially constant output voltage or power while the input source (e.g., power factor inductor) operates. In alternative embodiments, an alternating current is used to power the operation of the ballast.

In act 46, an auxiliary power output is supplied from the ballast. The auxiliary output is powered from the mains power. The same or different power generation in act 44 is used for auxiliary power. For example, power is generated from the power factor inductor with a same or different type, but separate circuit. A direct or alternating current is output.

The auxiliary power output powers a device separate from the lighting load. The auxiliary device may be a light or lamp, but connects to a different output than the ballasted lamp.

In act 48, the auxiliary power output is referenced to a potential, such as ground. The reference is provided by connecting to the reference. The reference may be floating, resulting in the reference being a difference in potential across an inductor in the embodiment of FIG. 2. The reference may be a local ground, a line, an earth, or a neutral connection. In one embodiment, the reference is selectable. By manual or automatic connection or switching, the reference is connected to one or of a plurality of possibly desired potentials.

While the invention has been described above by reference to various embodiments, it should be understood that many changes and modifications can be made without departing from the scope of the invention. It is therefore intended that the foregoing detailed description be understood as an illustration of the presently preferred embodiment of the invention, and not as a definition of the invention. It is only the following claims, including all equivalents, which are intended to define the scope of this invention.

I (we) claim:

1. A lighting ballast comprising:
a mains input;
electronics operable to ballast a lighting load from power at the mains input;
a first power supply circuit for the electronics, the first power supply circuit being powerable by the power at the mains input;
a second power supply circuit separate from the first power supply circuit, the second power supply comprising a charge pump circuit; and
an auxiliary power output connected with the second power supply circuit.

2. The lighting ballast of claim 1 wherein the electronics comprise a controller, processor, integrated circuit, or combinations thereof.

3. The lighting ballast of claim 1 wherein the charge pump circuit comprises a secondary winding of a power factor controller inductor, a resistor and first capacitor in series with the secondary winding, a zener diode connected between the first capacitor and a ground, and a diode connected between the first capacitor and a second capacitor.

4. The lighting ballast of claim 1 wherein the second power supply circuit comprises a separate pump charge circuit.

5. The lighting ballast of claim 1 wherein the second power supply circuit comprises a secondary winding of a power factor controller inductor, a resistor and first capacitor in series with the secondary winding, a zener diode connected between the first capacitor and a ground, and a diode connected between the first capacitor and a second capacitor.

6. The lighting ballast of claim 1 wherein the first and second power supply circuits comprise separate secondary windings of a power factor controller inductor.

7. The lighting ballast of claim 1 wherein the second power supply circuit comprises reference potential connectors for line, neutral and earth potentials.

8. The lighting ballast of claim 1 further comprising a fan connected with the auxiliary power output.

9. The lighting ballast of claim 1 wherein the second power supply circuit is operable to output a direct current to the auxiliary power output.

10. A method for powering devices adjacent a lighting ballast, the method comprising:
ballasting, with a ballast, a lighting load from a mains power;
powering operation of the ballast from the mains power; and
supplying an auxiliary direct current output from the ballast with a charge pump circuit, the auxiliary direct current output powered from the mains power.

11. The method of claim 10 wherein ballasting comprises ballasting a high intensity discharge lamp.

12. The method of claim 10 wherein powering operation of the ballast comprises generating a direct current with power from a power factor inductor.

13. The method of claim 12 wherein supplying comprises generating with power from the power factor inductor.

14. The method of claim 10 wherein supplying the auxiliary direct current output comprises supplying with a separate circuit than used for powering operation of the ballast.

15. The method of claim 10 further comprising:
referencing the auxiliary direct current output to selectable line, neutral, and earth potentials.

16. A system for auxiliary power supply associated with lighting, the system comprising:
a high intensity discharge lighting ballast; and
an auxiliary direct current output of a charge pump circuit on the lighting ballast.

17. The system of claim 16 wherein the high intensity discharge lighting ballast comprises a first direct current power supply powered from a mains input, and wherein the auxiliary direction current output connects with a second direct current power supply powered from the mains input, the first direct current power supply separate from the second direct current power supply.

18. The system of claim 16 wherein a reference potential of the auxiliary direct current output is a selectable one of line, neutral and earth phases of a mains.
